(19) United States
(12) Patent Application Publication
(10) Pub. No.: US 2026/0368859 A1
(43) Pub. Date: Nov. 19, 2026

(54) IMAGE CORRECTION METHOD, ELECTRONIC DEVICE AND STORAGE MEDIUM

(71) Applicant: TRIPLE WIN TECHNOLOGY(SHENZHEN) CO.LTD., Shenzhen (CN)

(72) Inventor: HSIANG-CHIEH YU, NewTaipei (TW)

(21) Appl. No.: 19/424,385

(22) Filed: Dec. 18, 2025

(30) Foreign Application Priority Data
May 14, 2025 (CN) 202510621249.2

(51) Int. Cl. G06T 5/50; G06T 5/20; G06T 5/70; G06T 7/73

(52) U.S. Cl. CPC G06T 5/50; G06T 5/20; G06T 5/70; G06T 7/73; G06T 2207/10048

(57) ABSTRACT

The present application belongs to a field of image processing and provides an image correction method, an electronic device, and a storage medium. The method determines a focal plane array (FPA) temperature corresponding to an initial thermal image; determines a first correction parameter corresponding to the FPA temperature using a two-point correction algorithm; obtain a first image by correcting non-uniformity of the initial thermal image based on the first correction parameter; determine a target temperature based on pixel values of the first image; determine a second correction parameter based on the target temperature; obtain a second image by using the second correction parameter to correct the first image. The method can improve an accuracy of thermal infrared imaging correction.

### CROSS-REFERENCE TO RELATED APPLICATIONS

The present application claims priority to Chinese Patent Application No. 202510621249.2 filed on May 14, 2025, in China National Intellectual Property Administration, the contents of which are incorporated by reference herein.

### FIELD

The present application relates to a field of image processing, specifically to an image correction method, an electronic device, and a storage medium.

### BACKGROUND

In an uncooled thermal infrared imaging system, a temperature of a focal plane array fluctuates with changes in ambient temperature and operating time, leading to variations in the spatial non-uniformity of the focal plane array and consequently reducing the quality of thermal infrared imaging. Related thermal infrared imaging correction methods typically calibrate only for a specific temperature, and each pixel of thermal infrared imaging usually has only one fixed set of gain and offset, resulting in low correction accuracy. This leaves many residual non-uniformities in the thermal infrared image, causing problems such as image artifacts and reduced thermal contrast.

### BRIEF DESCRIPTION OF THE DRAWINGS

To more clearly illustrate technical solutions of the embodiments of the present application, the drawings used in the description of the embodiments of the present application will be briefly introduced below. Obviously, the drawings described below are only some embodiments of the present application. For those skilled in the art, other drawings can be obtained based on these drawings without creative effort.

FIG. 1 is a structure schematic diagram of an electronic device for an image correction method provided in an embodiment of the present application.

FIG. 2 is a flowchart of an image correction method provided in an embodiment of the present application.

FIG. 3 is a schematic diagram of a correction image provided in an embodiment of the present application.

FIG. 4 is a flowchart of an image correction method provided in another embodiment of the present application.

FIG. 5 is a functional block diagram of an image correction device provided in an embodiment of the present application.

### DETAILED DESCRIPTION

The technical solutions of the embodiments of the present application will be clearly and completely described below with reference to the accompanying drawings. Obviously, the described embodiments are only some embodiments of the present application, not all embodiments. Based on the embodiments of the present application, all other embodiments obtained by those skilled in the art without creative effort are within the scope of protection of the present application.

Hereinafter, the terms “first” and “second” are used for descriptive purposes only and should not be construed as indicating or implying relative importance or implicitly specifying the number of indicated technical features. Thus, a feature defined as “first” or “second” may explicitly or implicitly include one or more of that feature. In the description of embodiments of the present application, words such as “exemplary” or “for example” are used to indicate examples, illustrations, or descriptions. Any embodiment or design described as “exemplary” or “for example” in the embodiments of the present application should not be construed as being more preferred or advantageous than other embodiments or design solutions. Specifically, the use of words such as “exemplary” or “for example” is intended to present the relevant concepts in a specific manner.

Unless otherwise defined, all technical and scientific terms used herein have the same meaning as commonly understood by one of ordinary skill in the art to which the present application pertains. The terminology used in the present application's specification is for the purpose of describing particular embodiments only and is not intended to be limiting of the application. It should be understood that, unless otherwise stated, “/” in the present application means “or”. For example, A/B can mean A or B. “And/or” in the present application is merely a description of the relationship between related objects, indicating that three relationships can exist. For example, A and/or B can represent: A alone, A and B simultaneously, and B alone. “At least one” refers to one or more. “More than one” refers to two or more. For example, at least one of a, b, or c can represent: a, b, c, a and b, a and c, b and c, and a, b, and c (seven cases).

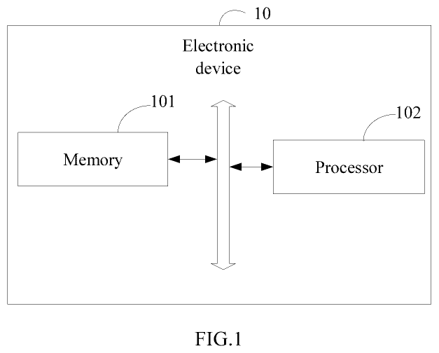

FIG. 1 shows a structure schematic diagram of an electronic device for an image correction method provided in an embodiment of the present application.

In the embodiments of the present application, the image correction method is applied to one or more electronic devices 10. The electronic device 10 is a device capable of executing computer-readable instructions to automatically perform numerical calculations and/or information processing. The hardware of the electronic device includes, but is not limited to, microprocessors, application-specific integrated circuits (ASICs), field-programmable gate arrays (FPGAs), digital signal processors (DSPs), embedded devices, etc.

The electronic device 10 can be any electronic product that can interact with a user, such as a personal computer, a tablet computer, a smartphone, a personal digital assistant (PDA), a game console, an interactive network television (IPTV), a smart wearable device, etc.

The electronic device 10 may include network devices and/or user devices. Among them, the network devices include, but are not limited to, a single network electronic device, a group of electronic devices consisting of multiple network electronic devices, or a cloud based on cloud computing consisting of a large number of hosts or network electronic devices.

The network in which the electronic device 10 is located includes, but is not limited to: the Internet, a wide area network, a metropolitan area network, a local area network, a virtual private network (VPN), etc.

In the embodiments of the present application, the electronic device 10 includes, but is not limited to, a memory 101, a processor 102, and computer-readable instructions stored in the memory 101 and executable on the processor 102, such as image correction programs.

Those skilled in the art will understand that the schematic diagram is merely an example of the electronic device 10 and does not constitute a limitation on the electronic device 10. It may include more or fewer components than shown, or combine certain components, or different components. For example, the electronic device 10 may also include input/output devices, network access devices, buses, etc.

The processor 102 can be a central processing unit (CPU), or other general-purpose processors, a digital signal processors (DSP), an application-specific integrated circuits (ASIC), a field-programmable gate arrays (FPGA), or other programmable logic devices, discrete gate or transistor logic devices, discrete hardware components, etc. The general-purpose processor can be a microprocessor, a processor, or any conventional processor. The processor 102 is the computational core and control center of the electronic device 10, connecting various parts of the electronic device 10 through various interfaces and lines, and executing the operating system of the electronic device 10 as well as various installed application programs and program code.

The memory 101 can be used to store computer programs and/or modules. The processor 102 implements various functions of the electronic device 10 by running or retrieving the computer programs and/or modules stored in the memory 101, and by calling the data stored in the memory 101. The memory 101 may mainly include a program storage area and a data storage area. The program storage area may store the operating system, application programs required for at least one function (such as sound playback function, image playback function, etc.), etc.; the data storage area may store data created according to the use of the electronic device, etc. In addition, the memory 101 may include a non-volatile memory, such as a hard disk, a memory, a plug-in hard disk, a smart media card (SMC), a secure digital (SD) card, a flash card, at least one disk storage device, a flash memory device, or other non-volatile solid-state storage device.

The memory 101 can be the external memory and/or internal memory of the electronic device 10. Furthermore, the memory 101 can be a memory in physical form, such as a memory stick, a TF card (Trans-flash Card), etc.

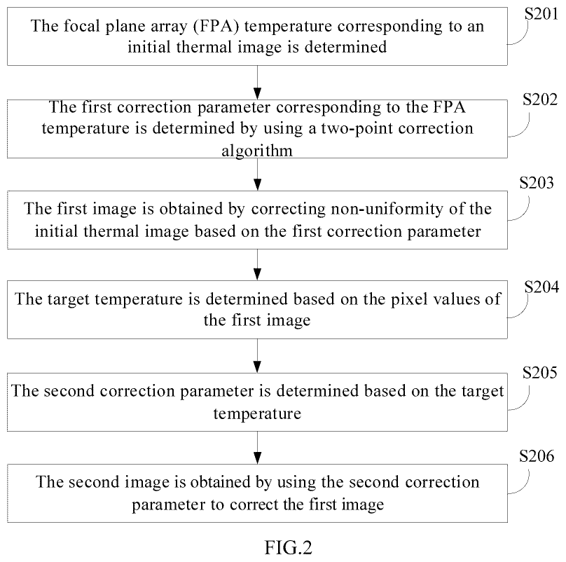

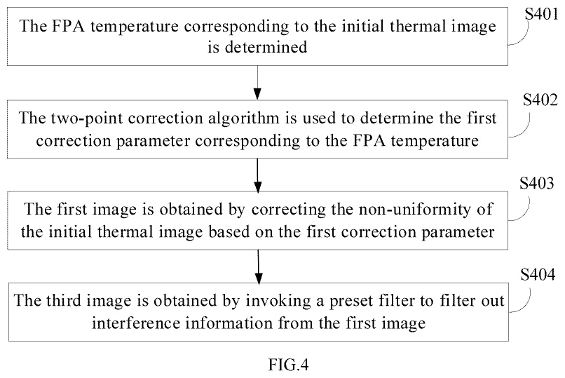

Referring to FIGS. 2 and 4, the memory 101 in the electronic device 10 stores computer-readable instructions, and the processor 102 can execute the computer-readable instructions stored in the memory 101 to implement multiple processes as shown in FIGS. 2 and 4 to realize the image correction method.

If the modules/units integrated in the electronic device 10 are implemented as software functional units and sold or used as independent products, they can be stored in a computer-readable storage medium. Based on this understanding, all or part of the processes in the methods of the above embodiments can also be implemented by instructing related hardware through computer-readable instructions. The computer-readable instructions can be stored in the computer-readable storage medium, and when executed by a processor, they can implement the steps of the various method embodiments described above.

FIG. 2 shows a flowchart of an image correction method provided in an embodiment of the present application. The image correction method can be applied to an electronic device, such as the electronic device 10 in FIG. 1. As shown in FIG. 2, the image correction method in the present embodiment includes steps S201-S206. Depending on different requirements, the order of the steps in the flowchart can be changed, and some steps can be omitted.

At block S201, the focal plane array (FPA) temperature corresponding to an initial thermal image is determined.

In at least one embodiment of the present application, the FPA temperature can be a temperature of an object's surface measured by an FPA sensor, and determined as follows: the FPA sensor can be integrated into a thermal imaging camera to collect infrared radiation at different locations on the object's surface. When the FPA sensor collects the infrared radiation, it can convert the infrared radiation at each location into an electrical signal.

The electronic devices use calibration data to convert electrical signals into relative radiation intensity. The calibration data includes the electrical signal values output by the FPA sensor at different temperatures, describing the FPA sensor's response characteristics at different temperatures. The conversion formula can be:

Iᵣₑₗ=f(Signal), wherein, Iᵣₑₗ can represent relative radiation intensity, f can represent a conversion function obtained from calibration data, and Signal can represent the electrical signal value.

The electronic device converts the relative radiation intensity into the FPA temperature, thus obtaining the FPA temperature at different locations. The conversion process is based on the Stefan-Boltzmann law and takes into account factors such as the emissivity of the object and the infrared radiation area received by the FPA sensor. A formula for determining the FPA temperature can be:

$$T = {( \frac{I \times A}{∈ \times σ} )}^{\frac{1}{4}} ,$$

where, T can represent the FPA temperature, I can represent the relative radiation intensity, A can represent the infrared radiation area received by the FPA sensor, and A is usually related to a sensor size and field of view, ∈ can represent emissivity of the object, σ can represent the Stefan-Boltzmann constant.

The present embodiment improves data processing efficiency by converting the infrared radiation into measurable electrical signals. Converting the electrical signal to relative radiation intensity using calibration avoids errors caused by equipment differences or environmental variations. The relative radiation intensity is then converted to FPA temperature using scientific formulas, providing readable temperature information and intuitive data support for temperature monitoring and analysis.

At block S202, the first correction parameter corresponding to the FPA temperature is determined by using a two-point correction algorithm.

In at least one embodiment of the present application, the first correction parameter includes a first gain value and a first offset value. The electronic device determining the first correction parameter corresponding to the FPA temperature, includes: the electronic device determining a standard temperature range corresponding to the FPA temperature from a pre-calibration database based on the real-time acquired FPA temperature. The pre-calibration database stores a set of correction parameters for the imaging system under different environmental conditions (such as temperature) calculated through two-point calibration. These parameters can be used to assist in the real-time dynamic adjustment of correction parameters and can be constructed and adjusted according to actual conditions. The electronic device determines the first correction parameter corresponding to the FPA temperature using an interpolation algorithm based on the gain value and offset value corresponding to the standard temperature range.

In one embodiment, the standard temperature range may include a first temperature and a second temperature, such as Tᵢ<FPA<Tᵢ+1, Tᵢ can represent the first temperature in the standard temperature range, and Tᵢ₊₁ can represent the second temperature in the standard temperature range. Based on the gain value and offset value corresponding to the first temperature and second temperature, the electronic device uses a linear interpolation formula to determine the first gain value and the first offset value corresponding to the FPA temperature.

A formular for determining the first gain value can be:

$${G}_{F P A} = {G}_{i} + \frac{{G}_{i + 1} - {G}_{i}}{{T}_{i + 1} - {T}_{i}} ( {T}_{F P A} - {T}_{i} ) ,$$

wherein G_{FPA} can represent the first gain value corresponding to the FPA temperature, Gᵢ can represent the gain corresponding to the first temperature, Gᵢ₊₁ can represent the gain corresponding to the second temperature, Tᵢ₊₁ can represent the second temperature, Tᵢ can represent the first temperature, and T_{FPA} can represent the FPA temperature.

A formula for determining the first offset value can be:

$${K}_{FPA} = {K}_{i} + \frac{{K}_{i + 1} - {K}_{i}}{{T}_{i + 1} - {T}_{i}} ( {T}_{FPA} - {T}_{i} ) ,$$

wherein K_{FPA} can represent the first offset value corresponding to the FPA temperature, Kᵢ can represent the offset corresponding to the first temperature, Kᵢ₊₁ can represent the offset corresponding to the second temperature, Tᵢ₊₁ can represent the second temperature, Tᵢ can represent the first temperature, and T_{FPA} can represent the FPA temperature.

For example, the pre-calibration database includes Table 1 as follows:

TABLE 1

| i | Ti | G | K |
|---|---|---|---|
| 1 | 20 °C | 0.1 | 0.06 |
| 2 | 40 °C | 0.15 | 0.1 |
| 3 | 60 °C | 0.2 | 0.2 |

Assuming the FPA temperature corresponding to a pixel location is 50 °C, then 40 °C<50 °C<60 °C, so T₂<FPA<T₃, corresponding to Tᵢ=40 °C, Tᵢ₊₁=60 °C, Gᵢ=0.15, Gᵢ+1=0.2, Kᵢ=0.1, Kᵢ₊₁=0.2. Substituting the above parameters into the formula to calculate the first gain value to obtain:

$${G}_{F P A} = 0.15 + \frac{0.2 - 0.15}{60 - 40} ( 50 - 40 ) = 0.175 ,$$

and calculate the first offset value to obtain:

$${K}_{F P A} = 0.1 + \frac{0.2 - 0.1}{60 - 40} - ( 50 - 40 ) = 0.15 .$$

Therefore, the first gain value corresponding to FPA is 0.175, and the first offset value is 0.15.

The present embodiment ensures that the gain value and the offset value corresponding to each temperature adapt to temperature changes by mapping the FPA temperature of the real-time scene image to a pre-corrected standard temperature range. Calculating the first correction parameter corresponding to the temperature by using a linear interpolation algorithm enables consistent correction performance under different FPA temperature conditions, thereby enhancing the reliability of the first correction parameter.

At block S203, the first image is obtained by correcting non-uniformity of the initial thermal image based on the first correction parameter.

In at least one embodiment of the present application, the first image may be an image after the non-uniformity of a fixed-mode noise has been compensated by the first correction parameter corresponding to the FPA temperature. The electronic device correcting the non-uniformity of the initial thermal image based on the first correction parameter to obtain the first image, includes: the electronic device determining a first correction output value corresponding to each pixel of the initial thermal image based on the first correction parameter (including the first gain value and the first offset value).

In one embodiment, the first correction output value for each pixel of the initial thermal image can be determined by performing mathematical operations on a raw output value of each pixel and corresponding gain value and offset value according to a formular. For example, the formula can be: Sᵢⱼ=Gᵢⱼ(T_{PPA})Rᵢⱼ+Kᵢⱼ(T_{FPA}), wherein Sᵢⱼ represents the first correction output value for the pixel ij, the pixel ij represents the pixel at coordinate (i, j) in the initial thermal image, Gᵢⱼ represents the first gain value corresponding to the pixel ij T_{PPA} represents the FPA temperature corresponding, to the pixel ij, Rᵢⱼ rep represents a raw value at the pixel ij, and Kᵢⱼ represents the first offset value corresponding to the pixel ij.

The electronic device obtains the first image based on the first correction output value. The first image is a result of non-uniformity correction, in which fixed-pattern noise is effectively compensated.

The present embodiment uses the first correction parameter and formulas to quickly obtain the first correction output value, thereby improving the determination efficiency of the first correction output value and thus improving the determination efficiency of the first image.

At block S204, the target temperature is determined based on the pixel values of the first image.

In at least one embodiment of the present application, the target temperature includes the temperature that minimizes the pixel difference value. The electronic device determining the target temperature corresponding to the FPA temperature in the first image, includes: the electronic device determining the pixel difference value between every two adjacent pixels corresponding to the FPA temperature in the first image. The pixel difference value reflects the changes in pixel values in the image and is a basis for subsequent calculations of the target temperature.

The electronic device determines the target temperature based on the pixel difference value by using a least squares method. In one example, based on the pixel values and the FPA temperature, the electronic device constructs a polynomial function as a linear model for the least squares method: P(T)=a₂T²++a₁T+a₀, wherein P(T) can represent the change in temperature T with respect to the difference between adjacent pixels, T can represent the target temperature to be solved, a₀ and a₁, a₂ represent polynomial coefficients.

When solving for the polynomial coefficients, partial derivatives with respect to a₀ a₁, a₂ are taken to obtain a system of equations. Substituting the FPA temperature and the pixel difference value between each pair of adjacent pixels corresponding to the FPA temperature into the system of equations, the polynomial coefficients a₀, a₁, a₂ are obtained.

When determining the target temperature, the least squares linear model P(T) is differentiated to obtain P′(T)=2a₂T+a₁. The target temperature includes the temperature at which the derivative P′(T) is zero; therefore, the formula for determining the target temperature is:

$${T}_{o p} = - \frac{{a}_{1}}{2 {a}_{2}} ,$$

wherein Tₒₚ represents the target temperature, a₁ and a₂ represents the polynomial coefficients. Based on the polynomial coefficients a₁ and a₂, the target temperature is calculated.

The present embodiment determines the target temperature based on the pixel difference value combined with the least squares method. The least squares method can effectively fit the nonlinear relationship between the temperature and pixel difference value, thereby improving the accuracy of the target temperature.

At block S205, the second correction parameter is determined based on the target temperature.

In at least one embodiment of the present application, the second correction parameter includes a second gain value and a second offset value. The electronic device determines the second gain value based on the target temperature and the first gain value in the first correction parameter; the electronic device determines the second offset value based on the target temperature.

In one embodiment, for each pixel, the electronic device selects an FPA temperature corresponding to the target temperature, and determines the second gain value based on the first gain value corresponding to the selected FPA temperature.

In one embodiment, the electronic device determines the second offset value based on the second gain value corresponding to the target temperature, radiation intensity of pixels of the first image, and the first correction output values of pixels of the first image. The formula for determining the second offset value can be: Bᵢⱼ=Sᵢⱼ−Aᵢⱼ×L, wherein Bᵢⱼ represents the second offset value corresponding to the pixel ij, Sᵢⱼ represents a first correction output value of a pixel of the first image, Aᵢⱼ represents the second gain value corresponding to the pixel ij, and L represents the radiation intensity of the pixel ij in the first image.

The present embodiment calculates the second correction parameter by considering a relationship between the target temperature and the FPA temperature, as well as the radiation intensity of the pixel and the first correction output value, thereby ensuring the accuracy and effectiveness of the correction process.

At block S206, the second image is obtained by using the second correction parameter to correct the first image.

In at least one embodiment of the present application, the second image may represent a final corrected image. The electronic device determines a second correction output value corresponding to each pixel of the first image based on second correction parameters and the target temperature. The second image is then obtained based on the second correction output values.

In one embodiment, the formula used to determine the second correction output value corresponding to each pixel of the first image can be: Zᵢⱼ=Aᵢⱼ(Tₙ)Sᵢⱼ+Bᵢⱼ(In) wherein Zᵢⱼ represents the second correction output value corresponding to the pixel ij, and the pixel ij represents the pixel at position coordinate (i, j) in the first image, Aᵢⱼ represents the second gain value corresponding to the pixel ij, Tₙ represents the target temperature, Sᵢⱼ represents the first correction output value at the pixel ij, and Bᵢⱼ represents the second offset value corresponding to the pixel ij.

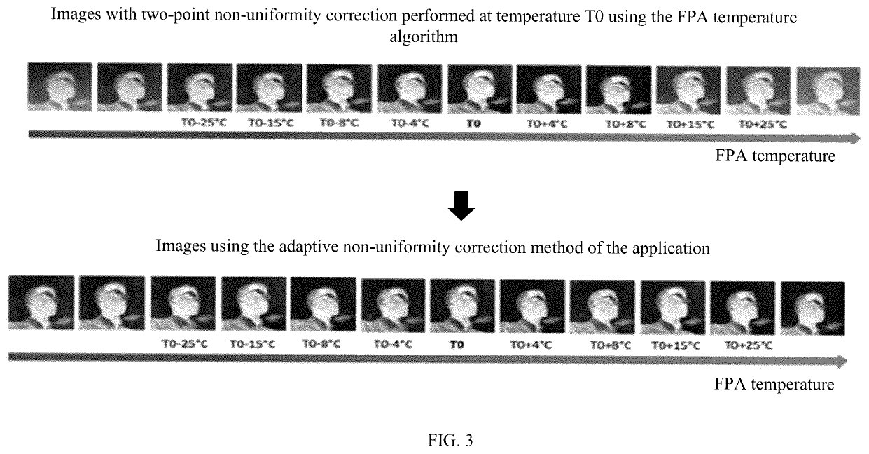

For example, as shown in FIG. 3, which is a schematic diagram of a correction image provided in an embodiment of the present application. In FIG. 3, “A” is an image obtained by using only two-point non-uniformity correction method, where the image quality and contrast decrease at different temperatures. In FIG. 3, “B” is an image obtained by using the non-uniformity correction combined with adaptive scene temperature change according to the present application, where the image quality and uniformity are better at different temperatures.

The present embodiment corrects the output value of the first image based on the second correction parameter. Since the second correction parameter is determined by the difference between adjacent pixels, there is a strong spatial correlation between adjacent pixels, which can remove the interference of spatial non-uniformity noise in the first image, thereby improving the image quality of the first image.

In other embodiments, if the initial thermal image is an image of a same scene, the electronic device can determine the correction temperature based on the pixel values of the initial thermal image, determine a third correction parameter based on the correction temperature, and correct the initial thermal image based on the third correction parameter to obtain a fourth image.

The present embodiment improves the quality of the fourth image by analyzing the scene in real time and compensating for non-uniformity based on pixel difference value, thus combining the non-uniformity of the thermal imaging image with real-time scene adaptive correction.

In several embodiments of the present application, by determining the FPA temperature corresponding to the initial thermal image, it can be ensured that the correction process is performed for the current FPA temperature state. Using the two-point correction algorithm to determine the first correction parameter corresponding to the FPA temperature allows the first correction parameter to adapt to changes in temperature conditions, thereby improving the accuracy and reliability of the correction parameter. Correcting the non-uniformity of the initial thermal image based on the first correction parameter to obtain the first image reduces fixed-pattern noise in the initial image and improves a signal-to-noise ratio. Determining the target temperature based on the pixel values of the first image improves the efficiency of target temperature determination because it does not rely on additional temperature references and only considers variations between pixels. Determining the second correction parameter based on the target temperature and dynamically adjusting the first correction parameter for the target temperature improves the accuracy of the second correction parameter. Correcting the first image using the second correction parameter to obtain the second image reduces spatial non-uniformity noise in the first image, thereby improving image clarity.

FIG. 4 shows a flowchart of an image correction method provided in an embodiment of the present application. The image correction method can be applied to the electronic device, such as the electronic device 10 in FIG. 1. As shown in FIG. 4, the image correction method in the present embodiment includes steps S401-S404. Depending on different requirements, the order of the steps in this flowchart can be changed, and some steps can be omitted.

At block S401, the FPA temperature corresponding to the initial thermal image is determined.

At block S402, the two-point correction algorithm is used to determine the first correction parameter corresponding to the FPA temperature.

At block S403, the first image is obtained by correcting the non-uniformity of the initial thermal image based on the first correction parameter.

For details of steps S401-S403, please refer to the detailed description of steps S201-S203 in FIG. 2 above, which will not be repeated here.

At block S404, the third image is obtained by invoking a preset filter to filter out interference information from the first image.

In some embodiments, the third image may also represent the final corrected image. The electronic device can use statistical methods to analyze the noise distribution characteristics of the first image and determine the noise type of the first image based on these characteristics. The electronic device then applies the filter corresponding to the noise type to denoise the interference information from the first image, obtaining the third image.

In determining the noise type of the first image, the electronic device can count the number of times each pixel value appears in the first image. The electronic device can then construct a histogram with the pixel values on a horizontal axis and the number of times each pixel value appears in the image on a vertical axis. Based on the histogram, the electronic device determines the noise type. For example, the histogram corresponding to Gaussian noise typically exhibits a normal distribution; the histogram corresponding to salt-and-pepper noise typically shows a bimodal characteristic in the extreme grayscale region.

The present embodiment determines the type of noise and calls an appropriate filter to denoise the interference information from the first image, thereby accurately removing the interference information from the first image and improving the quality of the third image.

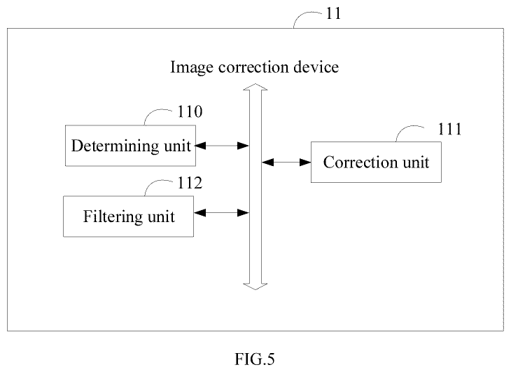

FIG. 5 shows a functional block diagram of an image correction device provided in an embodiment of the present application. The image correction device 11 includes a determining unit 110, a correction unit 111, and a filtering unit 112. The module/unit referred to in the present application refers to a series of computer-readable instruction segments that can be acquired by a processor (e.g., the processor 102 shown in FIG. 1) and can perform a fixed function, and is stored in a memory (e.g., the memory 101 shown in FIG. 1).

The determining unit 110 is used to determine the FPA temperature corresponding to the initial thermal image. The determining unit 110 is also used to determine the first correction parameter corresponding to the FPA temperature by using a two-point correction algorithm. The correction unit 111 is used to correct the non-uniformity of the initial thermal image based on the first correction parameter to obtain a first image; and the determining unit 110 is also used to determine the target temperature based on the pixel values of the first image; and the determining unit 110 is also used to determine the second correction parameter according to the target temperature; and the correction unit 111 is also used to correct the first image using the second correction parameter to obtain the second image.

In some embodiments, the determining unit 110 is specifically used to: determine the standard temperature range corresponding to the FPA temperature from the pre-calibration database based on the FPA temperature; and determine the first correction parameter corresponding to the FPA temperature using an interpolation algorithm based on the gain value and offset value corresponding to the standard temperature range.

In some embodiments, the correction unit 111 correcting the non-uniformity of the initial thermal image based on the first correction parameter to obtain the first image, includes: determining a first correction output value corresponding to each pixel of the initial thermal image based on the first correction parameter; and correcting the initial thermal image based on the first correction output value to obtain the first image.

In some embodiments, the determining unit 110 is further used to: determine the pixel difference value between every two adjacent pixels of the first image; and determine the target temperature based on the pixel difference value by using the least squares method, wherein the target temperature includes the temperature that minimizes the pixel difference value.

In some embodiments, the determining unit 110 is further used to: determine the second gain value based on the target temperature and the first gain value in the first correction parameter; and determine the second offset value based on the target temperature.

In some embodiments, the correction unit 111 is specifically used to: determine the second correction output value corresponding to each pixel of the first image based on the second correction parameters and the target temperature; and obtain the second image based on the second correction output value.

In some embodiments, the correction unit 111 is further used to: calculate the second correction output value corresponding to each pixel of the first image based on the second correction parameters and the target temperature, by using the following formula: Zᵢⱼ=Aᵢⱼ(Tₙ) Sᵢⱼ+Bᵢⱼ(Tₙ) wherein Zᵢⱼ represents the second correction output value corresponding to the pixel ij, and the pixel ij represents the pixel at position coordinate (i, j) in the first image, Aᵢⱼ represents the second gain value corresponding to the pixel ij, Tₙ represents the target temperature, Sᵢⱼ represents the first correction output value at the pixel ij, and Bᵢⱼ represents the second offset value corresponding to the pixel ij.

In some embodiments, the filtering unit 112 is used to invoke the preset filter to filter out the interference information from the first image and obtain the third image.

In several embodiments of the present application, by determining the FPA temperature corresponding to the initial thermal image, it can be ensured that the correction process is performed for the current FPA temperature state. Using a two-point correction algorithm to determine the first correction parameter corresponding to the FPA temperature allows the first correction parameter to adapt to changes in temperature conditions, thereby improving the accuracy and reliability of the correction parameter. Correcting the non-uniformity of the initial thermal image based on the first correction parameter to obtain the first image reduces fixed-pattern noise in the initial image and improves the signal-to-noise ratio. Determining the target temperature based on the pixel values of the first image improves the efficiency of target temperature determination because it does not rely on additional temperature references and only considers variations between pixels. Determining the second correction parameter based on the target temperature and dynamically adjusting the first correction parameter for the target temperature improves the accuracy of the second correction parameter. Correcting the first image using the second correction parameter to obtain the second image reduces spatial non-uniformity noise in the first image, thereby improving image clarity.

The processor 102 obtains the operating system and various installed applications of electronic device 10. The processor 102 obtains the applications to implement the steps in the above-described display method embodiments, such as the steps shown in FIG. 2 and FIG. 4.

For example, a computer program may be divided into one or more modules/units, one or more of which are stored in the memory 101 and retrieved by the processor 102 to complete the present application. One or more modules/units may be a series of computer program instruction segments capable of performing a specific function, which describe the process of retrieving the computer program from electronic device 10.

Computer-readable instructions include computer-readable instruction code, which can be in the form of source code, object code, executable file, or some intermediate form. Computer-readable media can include: any entity or device capable of carrying computer-readable instruction code, a recording media, a USB flash drive, a portable hard drive, a magnetic disk, an optical disk, a computer memory, a read-only memory (ROM), and a random access memory (RAM).

For example, computer-readable instructions can be divided into one or more modules/units, one or more of which are stored in the memory 101 and executed by the processor 102 to complete the present application. One or more modules/units can be a series of computer-readable instruction segments capable of performing specific functions, which describe the execution process of the computer-readable instructions in electronic device 10. For example, the computer-readable instructions can be divided into the determining unit 110, the correction unit 111, and the filtering unit 112.

For detailed information on the functions of each module/unit, please refer to FIGS. 2 and 4 above, which will not be repeated here. In the several embodiments provided in the present application, it should be understood that the disclosed systems, apparatuses, and methods can be implemented in other ways. For example, the apparatus embodiments described above are merely illustrative; for instance, the division of modules is only a logical functional division, and other division methods may exist in actual implementation.

The modules described as separate components may or may not be physically separate. The components shown as modules may or may not be physical units; that is, they may be located in one place or distributed across multiple network units. Some or all of the modules can be selected to achieve the purpose of the present embodiment according to actual needs.

Furthermore, the functional modules in the various embodiments of the present application can be integrated into one processing unit, or each unit can exist physically separately, or two or more units can be integrated into one unit. The integrated unit can be implemented in hardware or in the form of hardware plus software functional modules.

Therefore, the embodiments should be considered exemplary and non-limiting in all respects, and the scope of the present application is defined by the appended claims rather than the foregoing description. Thus, all variations falling within the meaning and scope of equivalents of the claims are intended to be embraced within the present application. No appended diagram markings in the claims should be construed as limiting the scope of the claims.

Furthermore, it is clear that the word “including” does not exclude other units or steps, and the singular does not exclude the plural. Multiple units or devices can also be implemented by a single unit or device through software or hardware. Terms such as “first,” “second,” etc., are used to indicate names and do not indicate any specific order.

Finally, it should be noted that the above embodiments are only used to illustrate the technical solutions of the present application and are not intended to limit it. Although the present application has been described in detail with reference to preferred embodiments, those skilled in the art should understand that modifications or equivalent substitutions can be made to the technical solutions of the present application without departing from the spirit and scope of the technical solutions of the present application.

What is claimed is:

1. An image correction method, comprising:
determining a focal plane array (FPA) temperature corresponding to an initial thermal image;
determining a first correction parameter corresponding to the FPA temperature using a two-point correction algorithm;
obtaining a first image by correcting non-uniformity of the initial thermal image based on the first correction parameter;
determining a target temperature based on pixel values of the first image;
determining a second correction parameter based on the target temperature;
obtaining a second image by using the second correction parameter to correct the first image.

2. The image correction method according to claim 1, wherein the first correction parameter comprises a first gain value and a first offset value, and using the two-point correction algorithm to determine the first correction parameter corresponding to the FPA temperature, comprises:
based on the FPA temperature, determining a standard temperature range corresponding to the FPA temperature from a pre-calibration database;
based on a gain value and an offset value corresponding to the standard temperature range, determining the first correction parameter corresponding to the FPA temperature by using an interpolation algorithm.

3. The image correction method according to claim 1, wherein obtaining the first image by correcting the non-uniformity of the initial thermal image based on the first correction parameter, comprises:
based on the first correction parameter, determining a first correction output value corresponding to each pixel of the initial thermal image;
obtaining the first image by correcting the initial thermal image based on the first correction output value.

4. The image correction method according to claim 1, wherein determining the target temperature based on the pixel values of the first image, comprises:
determining a pixel difference value between every two adjacent pixels of the first image;
based on the pixel difference value, determining the target temperature by using a least squares method, and the target temperature comprising a temperature that minimizes the pixel difference value.

5. The image correction method according to claim 1, wherein the second correction parameter comprises a second gain value and a second offset value, and determining the second correction parameter based on the target temperature, comprises:
determining the second gain value based on the target temperature and the first gain value in the first correction parameter;
determining the second offset value based on the target temperature.

6. The image correction method according to claim 1, wherein obtaining the second image by using the second correction parameter to correct the first image, comprises:
determining a second correction output value corresponding to each pixel of the first image based on the second correction parameter and the target temperature;
obtaining the second image based on the second correction output value.

7. The image correction method according to claim 6, wherein determining the second correction output value corresponding to each pixel of the first image based on the second correction parameter and the target temperature, comprises:
calculating the second correction output value using a formula Zᵢⱼ=Aᵢⱼ(Tₙ) Sᵢⱼ+Bᵢⱼ(Tₙ), wherein Zᵢⱼ represents the second correction output value corresponding to a pixel ij, ij represents one pixel at a position coordinate (i, j) in the first image, Aᵢⱼ represents the second gain value corresponding to the pixel ij, Tₙ represents the target temperature, represents the first correction output value at the pixel ij, and Bᵢⱼ represents the second offset value corresponding to the pixel ij.

8. The image correction method according to claim 1, wherein, after obtaining the first image by correcting the non-uniformity of the initial thermal image based on the first correction parameter, the image correction method further comprises:
obtaining a third image by invoking a preset filter to filter out interference information from the first image.

9. An electronic device comprising:
a processor;
a memory coupled to the processor; and
a non-transitory storage medium coupled to the processor and configured to store a plurality of instructions, which cause the processor to:
determine a focal plane array (FPA) temperature corresponding to an initial thermal image;
determine a first correction parameter corresponding to the FPA temperature using a two-point correction algorithm;
obtain a first image by correcting non-uniformity of the initial thermal image based on the first correction parameter;
determine a target temperature based on pixel values of the first image;
determine a second correction parameter based on the target temperature;
obtain a second image by using the second correction parameter to correct the first image.

10. The electronic device according to claim 9, wherein the plurality of instructions are further configured to cause the processor to:
wherein the first correction parameter comprises a first gain value and a first offset value, and the plurality of instructions are further configured to cause the processor to:
based on the FPA temperature, determine a standard temperature range corresponding to the FPA temperature from a pre-calibration database;
based on a gain value and an offset value corresponding to the standard temperature range, determine the first correction parameter corresponding to the FPA temperature by using an interpolation algorithm.

11. The electronic device according to claim 9, wherein the plurality of instructions are further configured to cause the processor to:
based on the first correction parameter, determine a first correction output value corresponding to each pixel of the initial thermal image;
obtain the first image by correcting the initial thermal image based on the first correction output value.

12. The electronic device according to claim 9, wherein the plurality of instructions are further configured to cause the processor to:
determine a pixel difference value between every two adjacent pixels of the first image;
based on the pixel difference value, determine the target temperature by using a least squares method, and the target temperature comprises a temperature that minimizes the pixel difference value.

13. The electronic device according to claim 9, wherein the second correction parameter comprises a second gain value and a second offset value, and the plurality of instructions are further configured to cause the processor to:
determine the second gain value based on the target temperature and the first gain value in the first correction parameter;
determine the second offset value based on the target temperature.

14. The electronic device according to claim 9, wherein the plurality of instructions are further configured to cause the processor to:
determine a second correction output value corresponding to each pixel of the first image based on the second correction parameter and the target temperature;
obtain the second image based on the second correction output value.

15. The electronic device according to claim 13, wherein the plurality of instructions are further configured to cause the processor to:
calculate the second correction output value using a formula Zᵢⱼ=Aᵢⱼ(Tₙ)Sᵢⱼ+Bᵢⱼ(Tₙ) to, wherein Zᵢⱼ represents the second correction output value corresponding to a pixel ij, ij represents one pixel at a position coordinate (i, j) in the first image, Aᵢⱼ represents the second gain value corresponding to the pixel ij, Tₙ represents the target temperature, Sᵢⱼ represents the first correction output value at the pixel ij, and Bᵢⱼ represents the second offset value corresponding to the pixel ij.

16. The electronic device according to claim 9, wherein the plurality of instructions are further configured to cause the processor to:
obtain a third image by invoking a preset filter to filter out interference information from the first image.

17. A non-transitory storage medium storing instructions, wherein in response to at least one processor of an electronic device executing the instructions, the least one processor is caused to execute an image correction method, the image correction method comprising:
determining a focal plane array (FPA) temperature corresponding to an initial thermal image;
determining a first correction parameter corresponding to the FPA temperature using a two-point correction algorithm;
obtaining a first image by correcting non-uniformity of the initial thermal image based on the first correction parameter;
determining a target temperature based on pixel values of the first image;
determining a second correction parameter based on the target temperature;
obtaining a second image by using the second correction parameter to correct the first image.

18. The non-transitory storage medium according to claim 17, wherein the first correction parameter comprises a first gain value and a first offset value, and using the two-point correction algorithm to determine the first correction parameter corresponding to the FPA temperature, comprises:
based on the FPA temperature, determining a standard temperature range corresponding to the FPA temperature from a pre-calibration database;
based on a gain value and an offset value corresponding to the standard temperature range, determining the first correction parameter corresponding to the FPA temperature by using an interpolation algorithm.

19. The non-transitory storage medium according to claim 17, wherein obtaining the first image by correcting the non-uniformity of the initial thermal image based on the first correction parameter, comprises:
based on the first correction parameter, determining a first correction output value corresponding to each pixel of the initial thermal image;
obtaining the first image by correcting the initial thermal image based on the first correction output value.

20. The non-transitory storage medium according to claim 17, wherein determining the target temperature based on the pixel values of the first image, comprises:
determining a pixel difference value between every two adjacent pixels of the first image;
based on the pixel difference value, determining the target temperature by using a least squares method, and the target temperature comprising a temperature that minimizes the pixel difference value.
